(19) United States
(12) Patent Application Publication
(10) Pub. No.: US 2013/0236794 A1
(43) Pub. Date: Sep. 12, 2013

(54) INORGANIC SOLID/ORGANIC LIQUID HYBRID ELECTROLYTE FOR LI ION BATTERY

(71) Applicants: Youngsik Kim, Fishers, IN (US); Nina Mahootcheian Asi, Indianapolis, IN (US); Joshua Paul Keith, Versailles, IN (US)

(72) Inventors: Youngsik Kim, Fishers, IN (US); Nina Mahootcheian Asi, Indianapolis, IN (US); Joshua Paul Keith, Versailles, IN (US)

(21) Appl. No.: 13/605,705

(22) Filed: Sep. 6, 2012

Related U.S. Application Data
(60) Provisional application No. 61/531,342, filed on Sep. 6, 2011.
(60) Provisional application No. 61/531,330, filed on Sep. 6, 2011.
(60) Provisional application No. 61/531,822, filed on Sep. 7, 2011.

(51) Int. Cl. H01M 10/056; H01M 10/0525

(52) U.S. Cl. CPC H01M 10/056; H01M 10/0525
USPC 429/306; 429/304; 429/319; 429/209; 429/224; 29/623.1

(57) ABSTRACT

A method for producing a hybrid electrolyte including preparing a housing, positioning a solid lithium ion conductor in the housing, and at least partially filling the housing with an organic liquid lithium ion conductor.

### CROSS-REFERENCE TO RELATED APPLICATIONS

This application claims priority to co-pending U.S. Provisional Patent Application Ser. No. 61/531,342 and 61/531,330, both filed on Sep. 6, 2011, and co-pending U.S. Provisional Patent Application Ser. No. 61/531,822, filed on Sep. 7, 2011, and incorporates the same herein in their respective entireties.

### TECHNICAL FIELD

The novel technology relates generally to electrochemistry, and, more particularly, to an electrolyte system for an electrochemical cell.

### BACKGROUND

The use of organic liquid electrolytes poses a challenge for further development of current lithium-ion battery technology due to the flammable liquid nature of the electrolyte that gives rise to safety problems, solvent leakage, and a tight electrochemical window. For these reasons, many lithium-ion conducting materials, such as polymer, polymer-gel, ionic liquid, and inorganic solids, have been investigated as alternative electrolytes for a lithium ion (Li-ion) battery. Among them, fast Li-ion conducting inorganic solid materials have been given attention as alternative candidates because of their advantages over liquid and polymer electrolytes such as their high Li-ion conductivity over 10⁻⁴ S/cm, their wide electrochemical window (0-7 V vs. Li⁺/Li⁰), and their good chemical stability with highly reducing and oxidizing electrodes.

For these reasons, many fast Li-ion conducting solids, such as sulfide glass, glass-ceramics, and oxy-sulfide glasses, have been developed. Due to their sulfurous character, they generally yield higher Li-ion conductivity than oxide compounds. However, they are generally very unstable in an air atmosphere, which gives rise to difficulty in handling. There are a few oxide compounds that yield high Li-ion conductivity up to 10⁻³ S/cm. These include the NASICON type: Li1.3Ti1.7Al_{0.3}(PO₄)₃, Garnet type: Li₇La₃Zr₂O₁₂, and LLTO type: Li₃ₓLa_{(2/3)-x( )(1/3)-2x}TiO₃ in this case.

Use of these fast Li-ion conducting solid materials as electrolytes has been intensively and extensively studied in the design of solid-state batteries that use a solid anode, cathode, and electrolyte. However, even with the high ionic conductive solid electrolytes, it has been a struggle to coax solid electrolyte battery to obtain similar specific capacity, rate capability, and cycle life to those of liquid electrolyte battery cells. One of common problems is that there is a large capacity decay after the first charge (or discharge) of the cell. Even at a very small current rate, the capacity and cycle life are limited.

Recent studies show that the major problems arise from the interfacing of a solid electrolyte with a solid electrode rather than simple the use of the solid electrolyte. To solve this problem, coating of ceramic on the surface of electrode particles has been performed to minimize the electrode/electrolyte interface resistance. However, the electrochemical performance has not been competitive to that of the cell in liquid electrolyte. Thus, there is a need for an improved electrolyte system for electrochemical cells. The present novel technology addresses this need.

### DESCRIPTION OF THE DRAWINGS

FIG. 1 is a schematic diagram of an electrochemical intersection.

FIG. 2 is a schematic diagram of a hybrid electrochemical cell of the present novel technology.

FIG. 3 is a graphic illustration of impedance versus pressure for the system of FIG. 2.

FIG. 4A graphically illustrates specific capacity as a function of voltage for the system of claim 2.

FIG. 4B graphically illustrates impedance change for the system of FIG. 2 after cycle charging.

FIG. 5 is a graph of initial impedance for various electrochemical cell configurations for the system of FIG. 2.

FIG. 5B schematically illustrates the conduction path through the hybrid electrolyte of FIG. 2.

FIG. 5C schematically illustrates the conduction path through a prior art solid state electrolyte.

FIG. 6A is a first graph of charge/discharge curves for various electrochemical cell configurations of FIG. 2.

FIG. 6B is a second graph of charge/discharge curves for various electrochemical cell configurations of FIG. 2.

FIG. 7A is a first graph of impedance curves for various electrochemical cell configurations.

FIG. 7B is a second graph of impedance curves for various electrochemical cell configurations.

FIG. 8A is a first graph of the change in voltage over time for the electrochemical cell of FIG. 2 at various temperatures.

FIG. 8B is a second graph of the change in voltage over time for the electrochemical cell of FIG. 2 at various temperatures.

### DESCRIPTION OF PREFERRED EMBODIMENTS

For the purposes of promoting an understanding of the principles of the novel technology, reference will now be made to the embodiments illustrated in the drawings and specific language will be used to describe the same. It will nevertheless be understood that no limitation of the scope of the novel technology is thereby intended, such alterations and further modifications in the illustrated device, and such further applications of the principles of the novel technology as illustrated therein being contemplated as would normally occur to one skilled in the art to which the novel technology relates.

Two problems with the above-described electrochemical cell designs remain to be addressed: 1) the coating materials are not soft enough to match the volume change of the electrode materials during Li insertion/extraction on discharge/charge of the cell; and 2) there may be an intrinsic problem of using an inorganic solid as the electrolyte for a Li-ion battery.

Following the above mentioned topic, the question is raised as to whether fast Li-ion conducting inorganic solids can work as an electrolyte if the interface problems are addressed and/or eliminated. Therefore, to minimize the problem of the solid electrolyte/solid electrode interface, the present novel technology relates to the addition of Li-ion conducting liquid between a solid electrode and a solid electrolyte. The use of liquid at the point of contact between a solid electrolyte and a solid electrode is also convenient to accommodate the volume change of electrode during Li insertion or extraction.

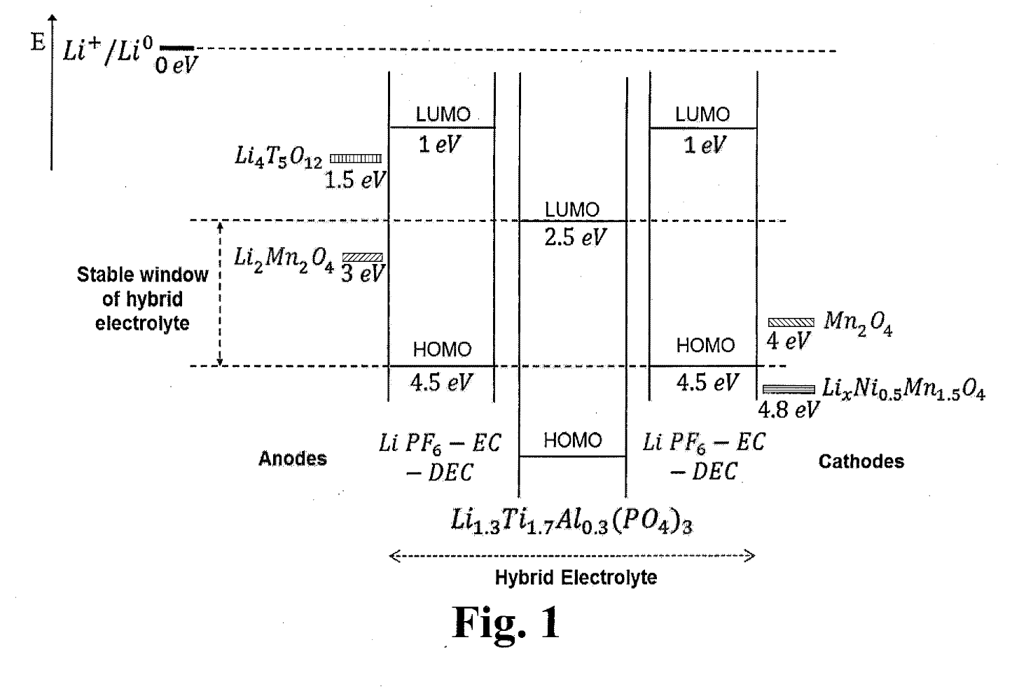

For relatively easy handling and synthesis, Li_{1.3}Ti_{1.7}Al_{0.3}(PO₄)₃ was selected in one embodiment to be the a solid electrolyte. As Li-ion conducting liquid, LiPF₆ in EC/DEC was selected as an organic electrolyte. With the use of Li_{1.3}Ti_{1.7}Al_{0.3}(PO₄)₃ as a solid electrolyte and LiPF6 in EC/DEC as a liquid electrolyte, a stable electrochemical window is only 2.5-4.5 V vs. Li⁺/Li⁰. To remove any other side effects such as the decomposition of liquid and solid electrolyte, LiMn₂O₄ was chosen as the material for both positive and negative electrodes. FIG. 1 shows that the Fermi energy of Li₂Mn₂O₄ and Mn₂O₄ are located in a stable window of both liquid and solid electrolytes. Hence, the charged and discharged shape of this material does not overlap the electrochemical intersection of solid and liquid electrolyte. As will be seen below, the interface impacts the electrochemical performance of a lithium ion cell.

Preparation of Li_{1.3}Ti_{1.7}Al_{0.3}(PO₄)₃ was modified as follows. A stoichiometric mixture of Li₂CO₃, Al₂O₃, TiO₂ and (NH₄)₂PO₄ was ground and heated in a platinum crucible at 300° C. for 2 hours and 900° C. for 2 h. The material was reground into fine powder using a ball mill for 2 hours by a wet milling process. The dried powder was reheated at 900° C. for 2 hours and then ball milled again for 5 h. The resultant milled powder was pressed into pellets. The pellets were fired at 1050° C. for 2 hours and cooled to room temp. The ionic conductivity of the prepared pellets was measured to be 1.03×10⁻³ S/cm.

Preparation of LiMn₂O₄ was accomplished as follows. A stoichiometric mixture of Li₂CO₃ and MnO₄ was ground and heated at 350° C. for 2 hours and then heated at 850° C. for 24 hours, followed by natural cooling.

In the preparation of electrodes for an all-solid-state cell and a hybrid electrolyte cell, the LiMn₂O₄ was mixed with the solid electrolyte and carbon in a weight ratio of 25:25:3 by using agate mortar and pestle. For each electrode a symmetric cell ten mg of mixture was used.

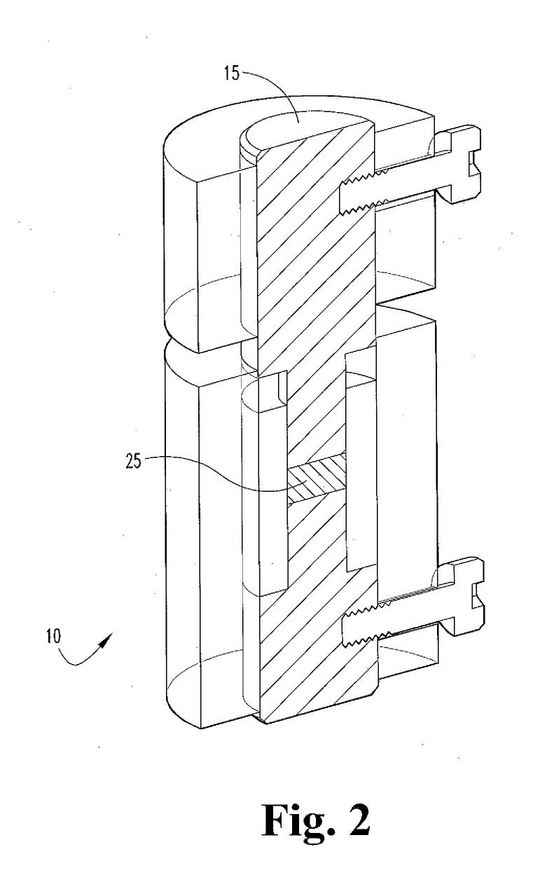

FIG. 2 schematically illustrates a solid state cell 10. Electrolyte powder (20 mg) was pelletized under the 1.75 Tones inside the aluminum tube with inside diameter of 6.4 mm. An electrode powder of 10 mg for each side was added to the pelletized electrolyte layer and pressed under the same pressure one by one. Three layers were hand pressed and were sandwiched by two stainless steel cylinders with a 6.4-mm-diameter. The cell 10 was charged and discharged at constant current of 0.05 mA at the temperature of 20° C.

After the electrolyte powder (20 mg) was pelletized under the 1.75 Tone inside the aluminum tube, 2 mg of liquid electrolyte was added between each electrode and electrolyte layers of all solid state symmetric cell of LiMn₂O₄/Li_{1.5}Ti_{1.7}Al_{0.5}(PO₄)₃/LiMn₂O₄ in argon filled dry box. The electrode powders (10 mg) for each side were added to the pelletized electrolyte and liquid electrolyte layer then those were pressed together at 2 Tone into a three layered pellet of 6.4-mm-diameter. The experiment was performed under a hand pressure vise with stainless steel current collectors on both sides.

The electrodes 15 for the coin cell 10 were fabricated from a 70:20:10 (wt %) mixture of active material, carbon as the current conductor and polytetrafluoroethylene as binder. The mixture was rolled into thin sheets and punched into 7-mm-diameter circular disks as electrodes. The typical electrode mass and thickness were 5-10 mg and 0.03-0.08 mm. The electrochemical cells 10 were prepared in standard 2016 coin-cell hardware with lithium metal foil used as both the counter and reference electrodes. The electrode disks 15 and cells 10 were prepared in an argon glove box. The electrolyte 25 used was 1M LiPF₆ in a 1:1 ethylene carbonate/diethyl carbonate.

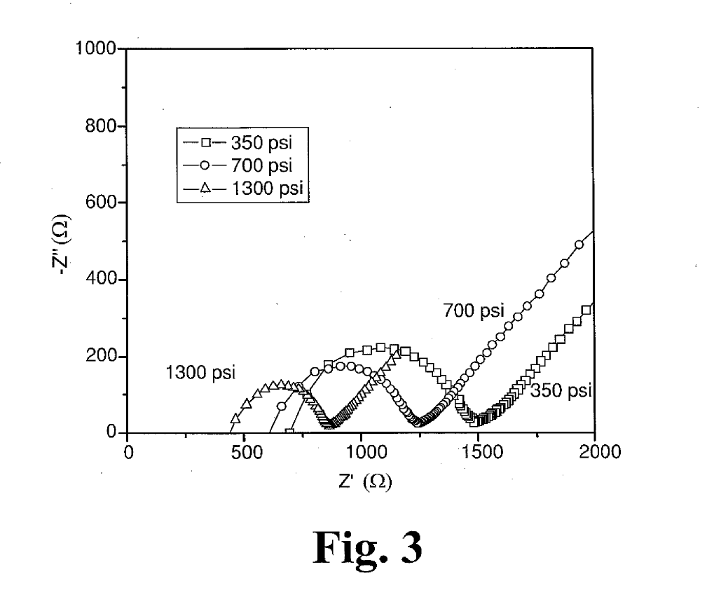

FIG. 3 shows the Electrochemical Impedance Spectroscopy (EIS) of the LiMn₂O₄ electrode 15/Solid Electrolyte 25/LiMn₂O₄ electrode 15 cell 10 at different pressures, 350, 700, and 1300 psi, respectively. Any pressure higher than 1300 psi risks rupture of the Al₂O₃ tube. Only one semicircle is observed for all samples. The left intercept of the semicircle with real axis corresponds to the solid electrolyte resistance (R_{SE}). The semicircle corresponding to the solid electrolyte is not generally observed in the high frequency region over 1 MHz due to its low resistance.

The size of the semicircle reflects the interface resistance (R_{IR}) between solid electrolyte particles or electrolyte/electrode particles. The total resistance (R_{SE}+R_{IR}) of the samples is therefore obtained from the right intercept of the semicircle with the real axis in the plots. The total conductivity (σₜ) of the cell 10 can be calculated from the measured total resistance (R_{SE}+R_{IR}) of the cell 10.

The impedance spectroscopy clearly shows that the total resistance of the cell 10 decreases as pressure increases. Both of the bulk and grain boundary resistances decrease at higher pressure. This is because higher pressure provides better contact between the solid electrolytes (reducing R_{SE}) and between the electrolyte/electrode (reducing R_{IR}).

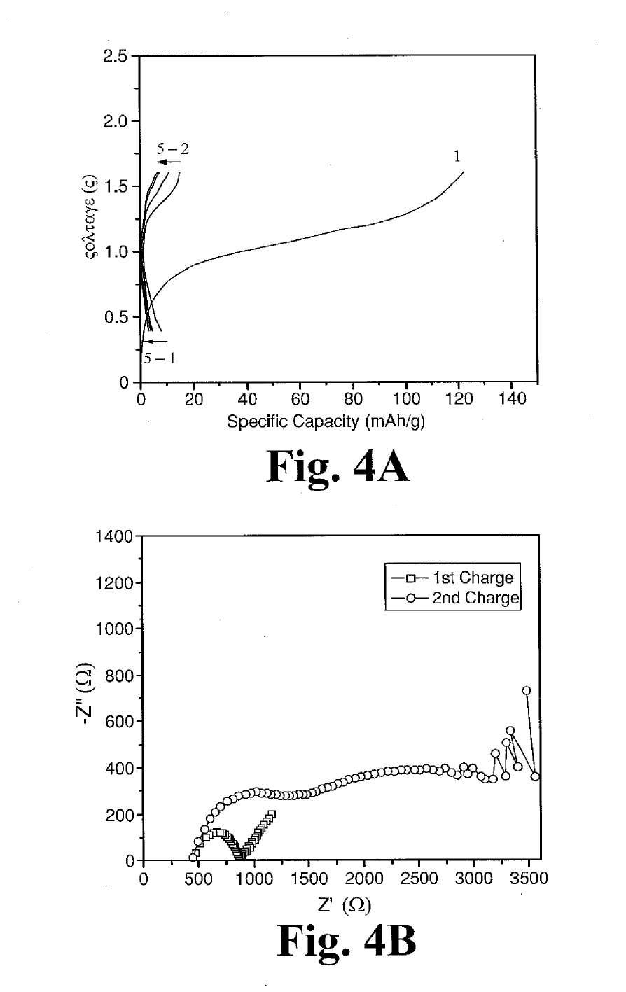

FIG. 4A shows the charge and discharge voltage test for the all-solid-state battery cell 10 composed of LiMn₂O₄/S.E./LiMn₂O₄. The pressure of 1300 psi is kept during the measurement to minimize the resistance of the cell 10. The cell 10 displays a smooth charge voltage curve during the first charge of the cell 10. The capacity reached 120 mAh/g. A current rate of 0.02 mA was selected. When a current higher than 0.02 mA is applied, a proper charge/voltage curve could not be maintained, which is common among other all-solid-state battery cells 10. Although elevated pressure was applied to the cell 10 a second time, the resulting capacity and cycle-life were not acceptable even at the low current rate of 0.02 mA.

FIG. 4B shows impedance profiles of the as-prepared all-solid-state cell 10 after charging to 1.6 V. There is a dramatic change of the impedance spectra after the first charging to 1.6 V. Two semicircles are observed at high frequency and low frequency region. The left intercept of the high frequency semicircle with real axis is the same as that of the as-prepared sample, which indicates that the solid electrolyte resistance (R_{SE}) doesn't change even after charging the cell 10.

During the charging process, Li-ion extracts from Li₁₋ₓMn₂O₄ in the cathode 30 and in the anode 35 Li-ion inserts into the Li₁₊ₓMn₂O₄. It is commonly known that there is a large interface resistance between the intercalation electrode 15 and solid electrolyte 25. As a result, two semicircle regions can be regarded as the resistances at Li₂Mn₂O₄/SE and Mn₂O₄/SE interfaces. The increase in interface resistance during the first charge will be the likely cause of decrease of the capacity following discharge and charge of the cell 10.

The interface resistance between solid electrode 15 and solid electrolyte 25 is quite a challenge for the all-solid-state battery 10. Although they initially have good contact under high pressure, the volume change of the electrode during Li insertion/extraction on charging/discharging is a critical problem. To address this problem, many studies have been done on coating ceramic onto the surface of the electrode materials to solve this problem. However, their performance is not comparative with that of liquid electrolyte. Therefore, adding a very small amount of liquid 80, just enough to make good contact between the solid electrolyte/solid electrode 25,15 allows volume adjustment during cycling of the cell 70.

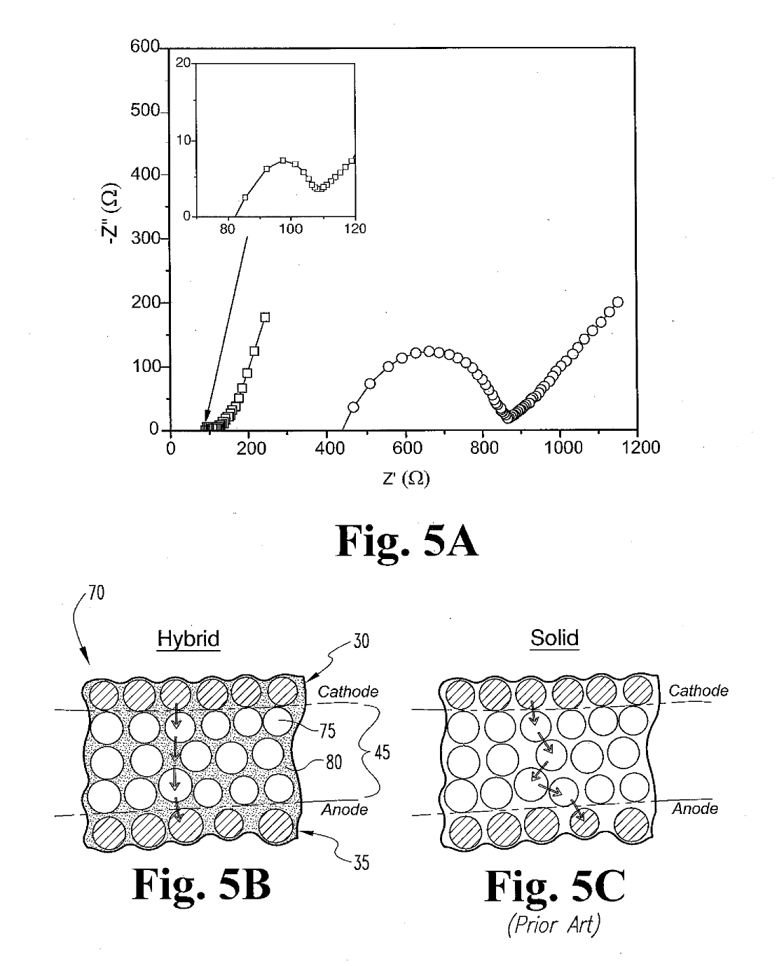

When 20 mg of solid electrolyte 75 and 10 mg of each electrode 15 are used, 2 mg of liquid electrolyte 80 is used between each electrode 15 and electrolyte 75, and the cell 70 is pressed under 1300 psi. FIG. 5 shows the impedance spectra of the hybrid electrolyte cell 70 compared with the solid electrolyte cell 10. The liquid 80 may be added to a solid electrolyte body 25, or may incorporate a plurality of inorganic particles 75 suspended in an organic liquid matrix 80

The size of the semicircle corresponding to the interface resistance decreases in the hybrid cell 70. In addition, the electrolyte resistance indicated by the left intercept of the semicircle with real axis also decreases to 80 ohm compared to 420 ohm of the solid electrolyte cell 10. So, total resistance decrease from 850 ohm to 110 ohm.

Even under high pressure, there will always be space between solid electrolyte particles 75, electrode 15 particles, and between solid electrolyte 25/solid electrodes 15 in general. The addition of liquid electrolyte 80 fills the gap between any of these solid particles. This can provide better Li-ion mobility in the hybrid cell 70. FIGS. 5B and 5C show the pathways of Li-ion in solid electrolyte cells 10 and hybrid cells 70. The total conductivity is calculated to be 2.84×10⁻⁴ S/cm for the solid electrolyte cell 10 and 2.03×10⁻³ S/cm for the hybrid cell 70. The ionic conductivity of 2.03×10⁻³ S/cm for the hybrid cell 70 is similar to the ionic conductivity, 1.0×10⁻³ S/cm, of Li_{1.3}Ti_{1.7}Al_{0.3}(PO₄)₃ pellet, but smaller than that (2.0×10⁻² S/cm) of liquid electrolyte 80.

Even though less than 10 wt % of liquid electrolyte 80 was used in the novel material, the cell 70 was tested to ensure that electrochemical performance arises from the hybrid electrolyte 45 (combination of solid 25 and liquid electrolyte 80) and not just from the liquid electrolyte 80. Thus, the hybrid electrolyte cell 70 was prepared with non-Li-ion conductive Al₂O₃ particles instead of using Li_{1.3}Ti_{1.7}Al_{0.3}(PO₄)₃. Proper impedance data was indistinguishable over the noise. Further, the hybrid cell 70 could not be charged or discharged with Al₂O₃ even at very low current rate of 0.005 mA/cm₂. This supports that the liquid electrolyte 80 typically doesn't penetrate the solid electrolyte pressed pellet 25 (the solid electrolyte material 25 may be present in the form of a solid body, plurality of particles, a plurality of particles formed into a green body, a plurality of particles sintered into a unitary body, or the like).

FIG. 9 illustrates one embodiment of a hybrid electrolyte 45, a housing 100 defined by a wherein which a solid lithium ion conductor 25 (in particulate form) is distributed and an organic lithium ion conducting liquid 80 is likewise distributed therein. The nonconducting matrix 100 may be a porous polymer, a foam, a gel, a fibrous matrix, or the like. In other embodiments, the housing 100 may be a coin shell, a cylinder, or the like, and may be formed of a polymer, a ceramic, a metal, a composite, or the like.

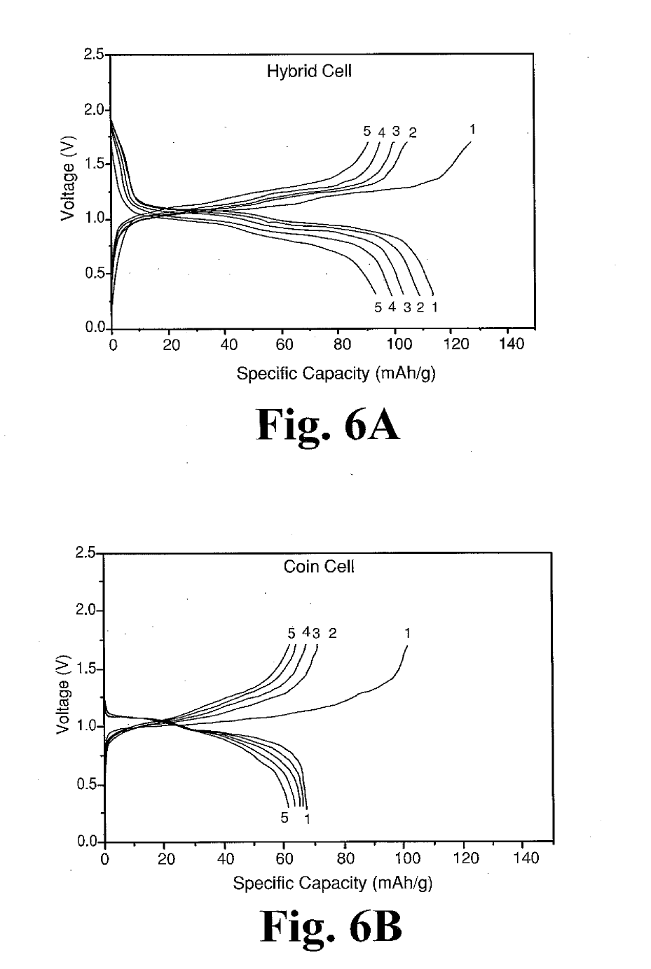

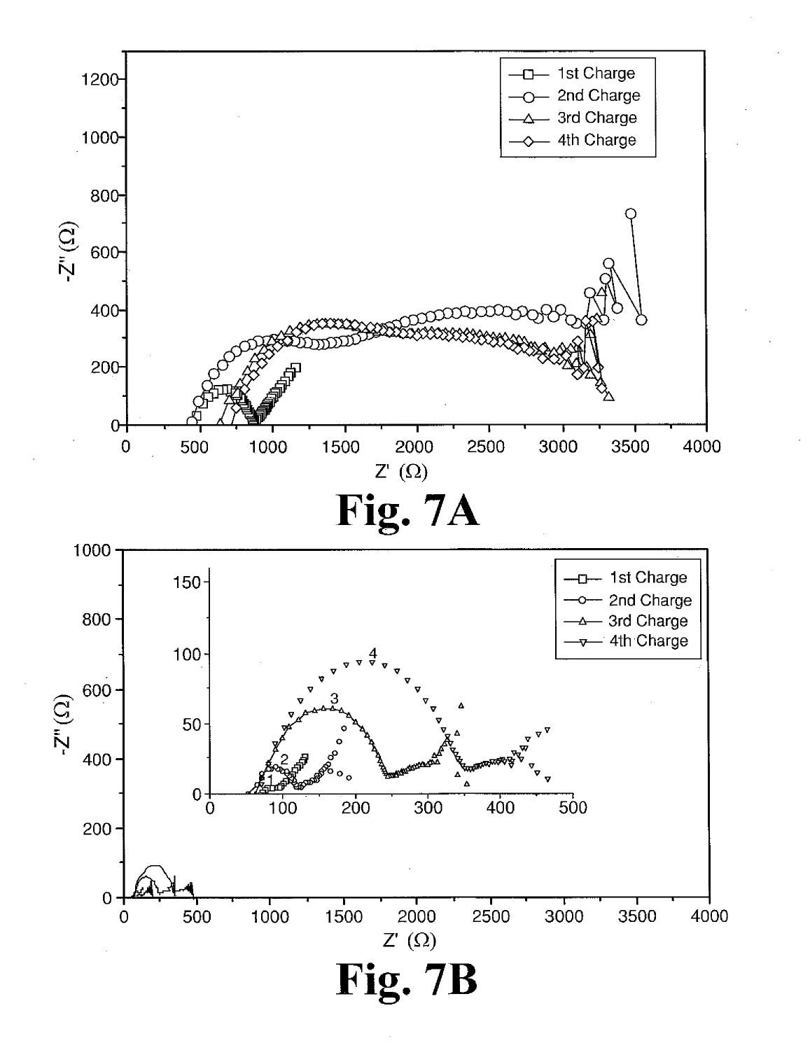

FIG. 6A shows the five cycles of charge and discharge voltage curves of the hybrid electrolyte cell 70. Compared with the pure solid electrolyte cell 10 of FIG. 4A, the hybrid cell 70 provides much better second discharge and following cycle capacity. This capacity is observed to be better than that of the pure liquid electrolyte 80 coin cell 90 in FIG. 6B.

Both sides of electrodes 15 are LiMn₂O₄ as anode 35 and cathode 30. In liquid electrolyte 80, the electrode spinel LiMn₂O₄ gives rise to an electrode-electrolyte reaction. The electrode surface disproportionation reaction 2Mn³⁺=Mn²⁺+Mn⁴⁺ results in dissolution of the Mn²⁺ from the electrode 15 into the electrolyte 80. This reaction, unless suppressed, gives an irreversible capacity loss of the electrode 15 and migration of the Mn²⁺ across the electrolyte 15 to the anode 35 during charge and blocks Li-ion insertion into the anode 35. This eventually leads to poor cycle life of the cell 90 using LiMn₂O₄ electrode 15.

In addition to poor cycle life, a large capacity loss between first charge and discharge is commonly observed in liquid electrolyte 80. This is also observed in FIG. 6C. On the other hand, the hybrid electrolyte cell 70 gives a larger first charge capacity, but it provides less capacity loss in the following discharge. This means that the less use of liquid electrolyte 80 improves the electrochemical properties of a LiMn₂O₄ electrode 15.

This shows the advantage of the use of the hybrid electrolyte 45 over pure solid electrolyte 25 and liquid electrolyte 80. Solid electrolyte 25 was used for the major electrolyte part to improve safety of batteries, and use liquid electrolyte 80 for minor part to provide better interface between solid electrode 15 and solid electrolyte 25. The smaller Li-ion conductivity of a solid electrolyte 25 compared to that of liquid 80 can be a problem for high current rate battery applications, but the hybrid system 45 combines the advantages of both to minimize current rate limitations.

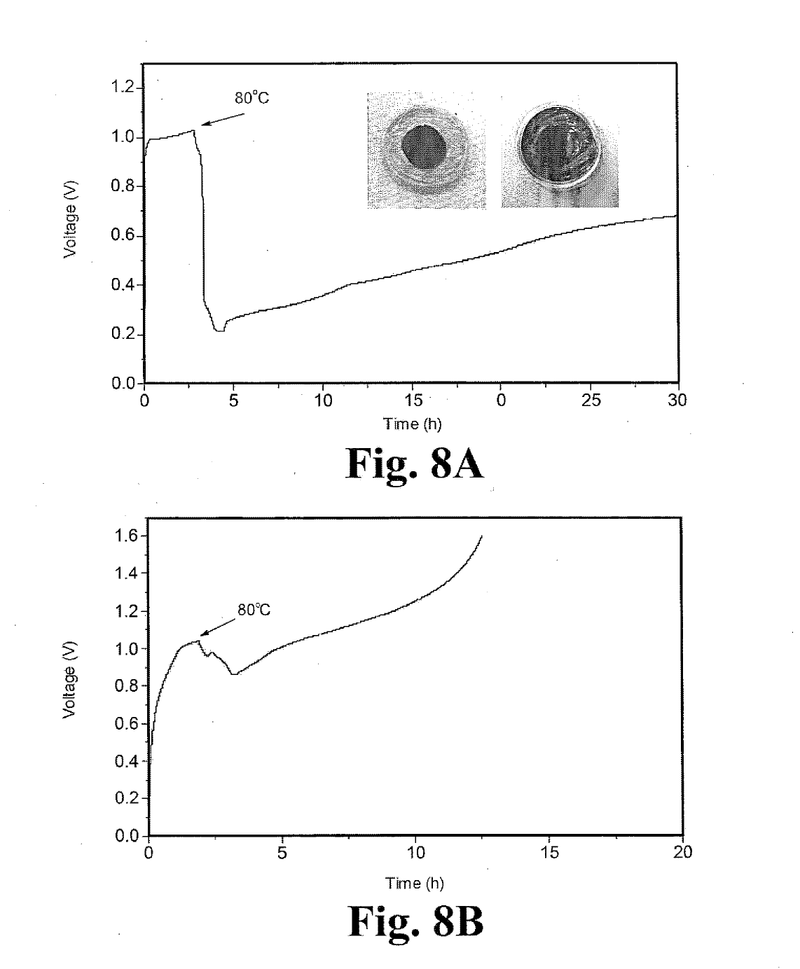

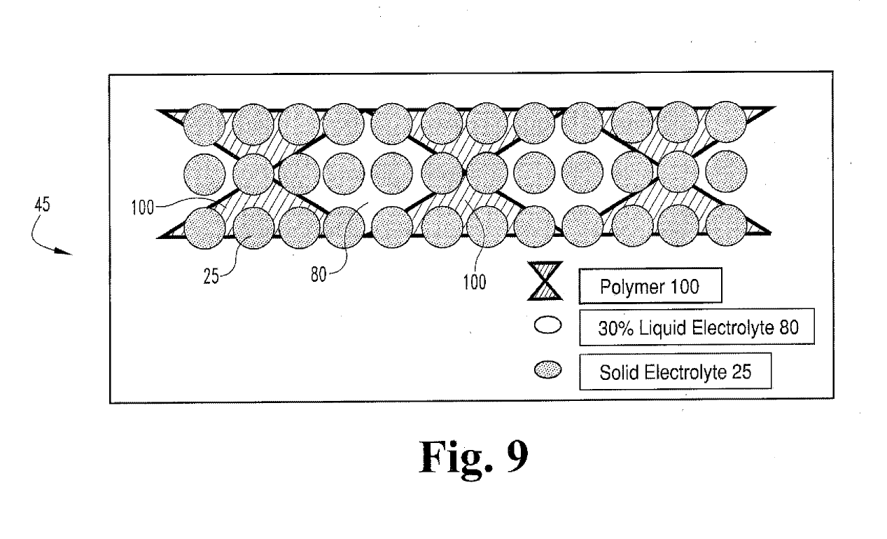

Another advantage of the use of a hybrid electrolyte system 45 over the use of pure liquid electrolyte 80 is that this hybrid system 45 can behave as a self-safety device when sudden higher temperature is applied. FIG. 8 shows that during the charge of the coin cell 90 that used liquid electrolyte 80, the temperature increases and then the charge voltage drops. This would indicate the reaction between electrode 15 and electrolyte 80 occurs, which if not continued would cause catastrophic failure of the battery 90 producing gas then fire. However, for the cell 70 with a hybrid electrolyte 45, when the temperature increases, the voltage drops and thus the cell 70 stops.

While the novel technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the novel technology are desired to be protected.

We claim:

1. A hybrid electrolyte for a lithium ion electrochemical cell, comprising:
a solid lithium ion conducting portion; and
a lithium ion conducting liquid portion in lithium ionic communication with the a solid lithium ion conducting portion.

2. The hybrid electrolyte of claim 1, wherein the lithium ion conducting liquid portion is LiPF6.

3. The hybrid electrolyte of claim 1 wherein the solid lithium ion conducting portion is Li_{1.3}Ti_{1.7}Al_{0.3}(PO₄)₃.

4. The hybrid electrolyte of claim 1 wherein the solid lithium ion conducting portion is a plurality of particles.

5. The hybrid electrolyte of claim 4 and further comprising a polymer matrix, wherein the particulate Li_{1.3}Ti_{1.7}Al_{0.3}(PO₄)₃ is substantially homogeneously dispersed in the polymer matrix and wherein the lithium ion conducting liquid portion is at least partially absorbed into the polymer matrix.

6. A lithium ion electrochemical cell, comprising:
a first electrode;
a second electrode;
a lithium ion conducting liquid portion positioned between the first and second electrodes; and
a particulate inorganic lithium conducting portion dispersed in the lithium ion conducting liquid portion;
wherein the first and second electrodes are in ionic communication with the lithium ion conducting liquid portion.

7. The electrochemical cell of claim 6 wherein the first and second electrodes are LiMn₂O₄.

8. The electrochemical cell of claim 6 wherein the particulate inorganic lithium conducting portion is Li_{1.3}Ti_{1.7}Al_{0.3}(PO₄)₃.

9. The hybrid electrolyte of claim 8 and further comprising a polymer matrix positioned between the first and second electrodes, wherein the particulate inorganic lithium conducting portion is substantially homogeneously dispersed in the polymer matrix and wherein the lithium ion conducting liquid portion at least partially fills the polymer matrix.

10. An electrolyte composition for a lithium ion electrochemical cell, comprising:
an organic lithium ion conducting portion; and
a plurality of inorganic lithium ion conducting solid portions in contact with the organic lithium ion conducting portion.

11. The composition of claim 10 wherein the plurality of inorganic lithium ion conducting solid portions are sintered to define a unitary body.

12. The composition of claim 10 wherein the plurality of inorganic lithium ion conducting solid portions are Li_{1.3}Ti_{1.7}Al_{0.3}(PO₄)₃ and the organic lithium ion conducting portion is LiPF₆.

13. The composition of claim 12 and further comprising a polymer matrix, wherein the plurality of inorganic lithium ion conducting solid portions are dispersed in the matrix and wherein the organic lithium ion conducting portion is dispersed in the matrix.

14. A method for producing a hybrid electrolyte comprising:
a) preparing a housing;
b) positioning a solid lithium ion conductor in the housing; and
c) at least partially filling the housing with an organic liquid lithium ion conductor.

15. The method of claim 14 wherein the housing is an electrically nonconducting matrix and the solid lithium ion conductor is a plurality of particles.
